(19) United States
(12) Patent Application Publication
(10) Pub. No.: US 2008/0320552 A1
(43) Pub. Date: Dec. 25, 2008

(54) ARCHITECTURE AND SYSTEM FOR ENTERPRISE THREAT MANAGEMENT

(76) Inventors: Tarun Kumar, Bangalore (IN); Venkata Bulusu, Bangalore (IN); Balasubramanian Meenakshi, Bangalore (IN); Saket Dwivedi, Tanda (IN); Harsha R. Angeri, Bangalore (IN); Vikram J. Arora, Bangalore (IN)

Correspondence Address: HONEYWELL INTERNATIONAL INC., 101 COLUMBIA ROAD, P O BOX 2245, MORRISTOWN, NJ, 07962-2245, US

(21) Appl. No.: 12/142,122

(22) Filed: Jun. 19, 2008

Related U.S. Application Data
(60) Provisional application No. 60/945,143, filed on Jun. 20, 2007.

(51) Int. Cl. H04L 9/00

(52) U.S. Cl. 726/1

(57) ABSTRACT

Enterprise threat assessment and management provides both physical and logical security. Physical access control systems are configured to identify physical events in the physical domain, and logical access control systems are configured to identify logical events in the logical domain. Connectors establish uninterrupted coupling to the physical and logical access control systems. Event middleware is configured to selectively subscribe only to those events that correspond to defined policies. The policies define a correlation of the physical and logical events, actions are initiated depending upon the correlated physical and logical events defined by the policies.

### RELATED APPLICATION

This application claims the benefit of U.S. Provisional Application No. 60/945,143, filed Jun. 20, 2007, which is herein incorporated by reference in its entirety.

### BACKGROUND

Assets of organizations, and to some extent individuals, have shifted from being primarily physically based, i.e., goods, plants, machinery, paperwork, etc., to being data based, i.e., data files, video/voice information files, etc. This change in the asset base from being exclusively in the physical domain to being in both the physical domain and the logical domain has blurred the perimeter of an organization so that assets, which were accessible only within the bricks and mortar of the organization or individual, are now accessible from outside the physical plant. Thus, whereas a CEO, for example, could once be assured that, by implementing appropriate perimeter protection safeguards, all critical assets (including data) of the company, which were stored as hard copies, could not be improperly accessed, compromised, and/or duplicated, the CEO today knows that it is much more difficult to protect sensitive information because it is stored in data files rather than in physical form.

Indeed, company personnel frequently leave company premises carrying with them critical information stored on their laptops. Also, hundreds of copies of critical information can easily be made by authorized employees, increasing the risk that critical information can be improperly accessed. Thus, individuals and organizations are increasingly faced with the problem of unauthorized access to their data storage devices such as computers (including laptops and desktops), PDAs, etc. Hence, it is imperative to ensure that sensitive information stored in data storage devices does not fall into unauthorized hands.

Several mechanisms have been instituted to protect unauthorized access to a company's information asset base. Organizations have strong physical security systems put in place to restrict physical access to both physical and network resources of the organization. Also, to ensure that only the most trustworthy people are recruited as employees, serious background checking procedures are used during recruitment. Moreover, organizations have implemented strong network security systems (firewalls, IDS, VPN, etc.) in place to restrict access to network resources of the organization.

Despite all of these security measures, incidents involving improper access to information stored on data storage devices continue to occur. Practices such as tailgating (where an employee is followed in to a restricted space), password sharing, writing passwords in public places, leaving computers unlocked when unattended, frequent remote login (sometimes furthered by leaving the computer unattended), etc. create many loopholes allowing exploitation by an intruder. Moreover, a significant number of data violations are performed by disgruntled and possibly terminated employees.

Hence, it is important to restrict access privileges, both in the physical domain and in the logical domain, particularly to terminated employees.

Threats are not even limited to intrusion alone. In case of fire, physical assets as well as valuable information assets are threatened.

In retrospect, most threats can be addressed by understanding, in the right context, the events instigating or facilitating the threats, that is, by considering all events which have recently occurred in the past or are occurring currently. This event based approach has the potential of solving almost all imaginable threat scenarios.

As an example, today if an intruder tailgates a genuine user and enters a room, finds an unattended computer, finds the user's password (it is a common practice for people to leave their passwords written near their computers), and begins stealing information, there is no way to stop the intruder because the events leading up to the theft and the relevant physical and logical spaces in which the theft occurs are not related. If, however, both the events (or rather the lack of the physical event of door access) and the physical and logical spaces that support the events are understood in context of each other, this theft can be detected. For example, if there is no record of the intruder having entered the building and yet the intruder is accessing the network, a theft may be inferred.

The problem with the current approaches in detecting improper data access is due to a historical development. The physical security industry has evolved for thousands of years through the evolution of doors, locks, access control, etc. But the network security industry has evolved only during the last thirty years or so. As a result, these two industries representing their separate domains have always been looked at differently and separately. For example, organizations have had separate physical security and information system departments with separate budgets, separate reporting structures, and separate people working in these departments.

If the situation is analyzed from an enterprise risk approach, it may be realized that there is no need to look at events as falling within the purview of only one or the other of these domains. Instead, each event should be considered as possibly impacting both physical security of the building and the logical security of the data possessed by the occupants of the building. Thus, each event regardless of domain should be considered in order to determine whether it is within the purview of the enterprise as a whole. If it is, then in the ideal scenario, all such events should be individually considered, but in the right context so that a suitable decision can be made.

Thus, an approach is required to ensure that all tangible threats to the organization be considered in the right context and that a suitable response is implemented accordingly. In developing this approach, it must be recognized that disparate physical security and information, including network, security solutions have been used in the past, that different events occurring in physical and logical spaces have not heretofore been related, and that events occurring within the physical space or the logical space alone but at different times are difficult to relate. Any compromise in the security of the physical domain may result in compromise in the security of the logical domain and vice versa. Thus, any breach in one domain can influence the other domain. Accordingly, there is a need for a converged security solution that is aware of breaches cascading between physical and logical domains. A unified approach to handling security threats would be ideal to effectively manage enterprise security.

### BRIEF DESCRIPTION OF THE DRAWINGS

These and other features and advantages will become more apparent from the detailed description when taken in conjunction with the drawings in which:

FIGS. 1 and 2 illustrate an architecture of a physical and logical domain security system that can implement the enterprise threat management disclosed herein;

FIG. 3 illustrates an example connector for use in the architecture of FIGS. 1 and 2;

FIG. 4 illustrates an example rules engine for use in the architecture of FIGS. 1 and 2;

FIG. 5 illustrates a computer system as one example of a implementation of the physical and logical domain security system of FIG. 1; and,

FIG. 6 illustrates a flow chart of a program that may be executed by the computer system of FIG. 5 to identify threats to an enterprise.

### DETAILED DESCRIPTION

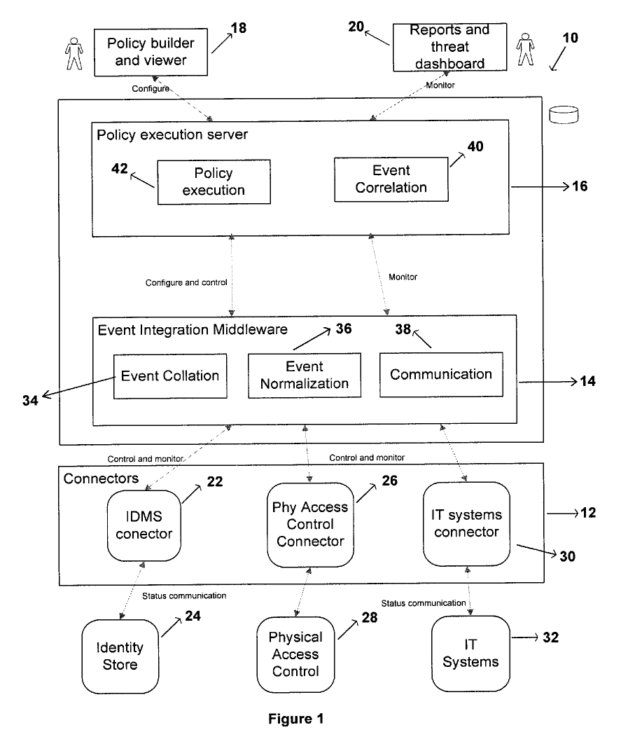

The architecture of a physical and logical domain security system 10 is shown in FIG. 1. The security system 10 includes connectors 12, event integration middleware 14, a policy execution server 16, a policy builder and viewer 18, and a report and user interface (UI) dashboard 20.

The connectors 12 are connectors to various subsystems shown by way of example at the lowest layer of FIG. 1. These connectors are a set of components with which the event integration middleware 14 interacts in order to collect events from the various physical and information technology subsystems. These connectors include an Integrated Document Management System (IDMS) connector 22 that collect events from the subsystems such as an IDMS subsystem 24, a physical access control connector 26 that collects events from a physical access control 28, and an information technology system connector 30 that collects events from information technology systems 32. Example events fetched by the IDMS connector 22 include access to documents stored by the IDMS subsystem 24 through which specific details regarding specific personnel such as date of joining, tenure in the concerned organization, etc. can be obtained. Example events fetched by the physical access control connector 26 include access control card IDs read by access control readers as personnel enter and exit controlled zones, total number of people who entered through a specific door within a specified time interval, etc. Example events fetched by the information technology system connector 30 include log IDs and pass words used during log on and log off events at various assets such as computers, time of plugging in of an external device such as a memory stick by an employee, transfer of data from a computer terminal to an external device such as a memory stick, etc.

The physical and logical domain security system 10 may be a centralized system with all functions of the physical and logical domain security system 10 being performed on a centralized computer or server. Alternatively, some of the functions of the physical and logical domain security system 10 may be performed on a centralized computer or server, and other functions of the physical and logical domain security system 10 may be performed on an asset being protected. Such other functions might involve sending messages to the event middleware or connectors on the occurrence of certain designated events. Such other functions can also be used to execute certain actions too.

The connectors 12 could be deployed on remote machines such as computers, access control readers, etc. The connector-based approach allows for the seamless addition of new event sources into this solution. This deployment addresses scalability requirements for handling event loads. In order to support scalability, the design of the connectors 12 should allow for multiple instances of the same connector.

Alternatively, the connectors 12 may reside on the same machine as the event integration middleware 14. The connectors 12 preferably, therefore, offer interfaces that may be accessed from remote machines, device, and/or subsystems.

Each instance of a connector 12 can have a unique identifier to help a connection manager 50 of the event integration middleware 14 to direct requests to the proper instance.

The connectors 12 also need to have a throttling mechanism that regulates the rate at which they send data to the upper layers 14 and 16. This feature is also included with the aim of supporting scalability; the throttling mechanism will ensure that upstream components do not get overwhelmed by data.

The event integration middleware 14 includes event collation 34 that examines the needs of policy execution and is responsible for collecting and collating events from disparate sources through the connectors 12, event normalization 36 that normalizes the collected and collated events as needed, and communication 38 that communicates any events/alerts back to the higher layers including the policy execution server 16. The event integration middleware 14 provides a bridge between these higher layers, such as the policy execution server 16, and the event sources or subsystems (such as the IDMS subsystem 24, the physical access control 28, and the information technology systems 32) downstream that need to be monitored to enforce policies of the enterprise. Event collation is the collection of events from the various subsystems provided through the respective connectors.

The policy builder and viewer 18 provide a graphical user interface for users to create security policies that they want the system 10 to enforce. The policy builder and viewer 18 provide the necessary constructs to express policies that span systems in both logical and physical domains. Examples of constructs include icons representing computers, access card readers, etc. Clicking on each icon will list the parameters that may be monitored. Constructs that represent logical AND and OR are also provided.

The policy builder and viewer 18 make it possible for the user to express these policies using drag and drop and connection of icons that represent the basic elements of such a policy. These policies are constructed in the form of rules. A policy is a collection of one or more rules. For example, a policy that governs employees working beyond office hours would restrict them from entering certain sensitive areas and from transferring large amounts of data over the network. This policy can be broken down into, for example, two rules—a) monitoring the swiping of the employee's access card and restricting his/her accesses to certain zones, b) finding the machine that this employee logs into and raising an alarm if the network traffic goes beyond a specified safe rate. Another example of a rule is that of detecting the swipe of a user's card at an exit door and locking the computer that the user was logged into if the user had not logged off. Swiping of the user's card at the exit door indicates that the user has gone out of the room.

The policy execution server 16 interprets the activity flow as provided by the policy builder and viewer 18, enforces the work flow as captured in the policy builder and viewer 18, and interfaces with the event integration middleware 14 to obtain the required events from the various subsystems 24, 28, and 32. Only those events that are required to execute the policies are obtained. Otherwise, events are not obtained by the policy execution server 16. The policy execution server 16 performs event collation 40 and policy execution 42.

The reports and UI dashboards 20 shows the current state of the policy being enforced. Based on user privileges, either high level or detailed alerts are displayed.

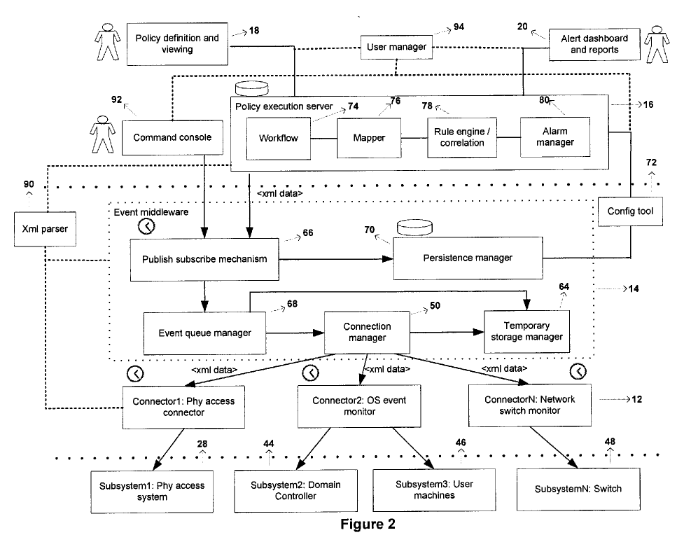

FIG. 2 is a more detailed view of the enterprise threat management architecture shown in FIG. 1.

The connectors 12 are responsible for interacting with the various devices and subsystems on the network and for fetching events from these various devices and subsystems. As discussed above, these devices and subsystems can include, inter alia, the IDMS subsystem 24, the physical access control 28, and the information technology systems 32. As shown in FIG. 2, they can also include a domain controller 44, various user machines 46, and various switches 48.

The events to be collected by the connectors 12 are specified by the event integration middleware 14. All data passed is passed using a predetermined format such as XML (extended Markup Language) format. The connectors 12 expose methods that are invoked by the event integration middleware 14 to initiate, modify or terminate the process of fetching events.

The policy execution server 16 selectively subscribes for the events needed to implement the policies. So, the event integration middleware 14 does not receive any events that are not of interest. The only decision that the event integration middleware 14 is required to make, if any, is to decide to which policy execution server it should rout events (but only in those cases where there are multiple policy execution servers). The policy execution server 16 processes only those events that are specified/used by any of the policies.

The system 10 is expected to interface with various kinds of devices, both physical and logical (information). Each of the connectors 14, therefore, may as desired be a module that interacts with just one type of device and has the capability to pass events from only devices of that type. Each of the connectors 12 translates events from the respective source (physical/IT/database etc.) into a uniform XML format that can be used by the event integration middleware 14. Subsequently, this XML format is used by the rest of the architecture, and the common format abstracts out details regarding disparate sources of the events.

An example of a physical access event by an employee with identifier E456789 is as follows:

<ETMS>

<HEADER>

<TYPE>EVENT</TYPE>
<NAME>PAC</NAME>

</HEADER>
<BODY>

<PAC>

<EMPID>E456789</EMPID>
<CARDNO>1234</CARDNO>
<ZONE>OFFICE2</ZONE>
<STATUS>IN</STATUS>
<ACCESSTIME>20-06-08 6:30 PM</ ACCESSTIME >

</PAC>

</BODY>

</ETMS>
)

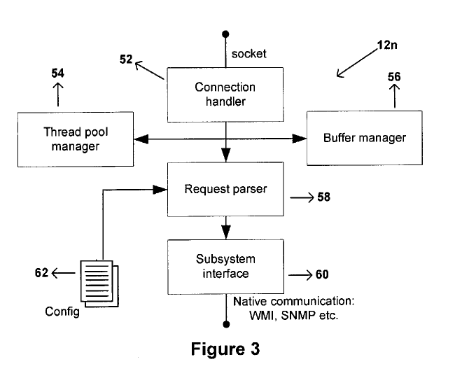

FIG. 3 describes structure for a typical connector 12n. The connector 12n includes a connection handler 52, a thread pool manager 54, a buffer manager 56, a request parser 58, a subsystem interface 60, and a configuration file 62.

The connection handler 52 handles the connection requests and establishes connections. It is responsible for routing the events received from the subsystem interface 60 to the appropriate connection. The subsystem interface 60 interfaces the connector 12n to a corresponding subsystem.

The event integration middleware 14 depends on the connection manager 50 to interface with the connectors 12 and to fetch events. The connection manager 50 maintains a connection for every specific event that is asked for by the event integration middleware 14. So, when the connection manager 50 receives an event from on of the connector2 12, it routes the event only to the connection that was “interested” in the event.

The thread pool manager 54 addresses the scalability needs of the connector 12n. The thread pool manager 54 maintains a pool of threads in order to service incoming connections. Each thread handles a specific number of connections.

The buffer manager 56 manages the queues (e.g., FIFO) needed for temporary storage of the events.

The request parser 58 parses all incoming connection requests to extract information needed by the respective connection. Events trapped from the sub-systems are analyzed to pass an event or a set of events to the specific connections. In the case of XML, requests come in as an XML request, and the parser 58 is then an XML parser that parses the requests to extract relevant fields using the XML tags.

The subsystem interface 60 provides a native interface to the underlying subsystems (physical, logical) such as the IDMS subsystem 24, the physical access control 28, and the information technology systems 32.

The configuration file 62 contains the configuration settings needed for the functioning of the connector 12n. Attributes of the connector 12n are defined in the configuration file 62.

The event integration middleware 14 is the layer that integrates logical (IT), physical, and other sources of security events to the application by interfacing with the connectors 12 to the various subsystems. The event integration middleware 14 interacts with the application and allows the application to subscribe for events of interest. These events that are subscribed to are fetched by interfacing with the subsystem integration layer (i.e., the connectors 12). This selective subscribing helps to achieve scalability with increase in the number of users and computer nodes in the enterprise.

The architecture described herein allows any application to interface with the event integration middleware 14. The policy execution server 16 is an example of such an application.

Subscription of an event involves asking to be informed when the event occurs. For example, if the policy execution server 16 subscribes for login events of Employee1, the policy execution server 16 is asking the event integration middleware 14 to inform it when Employee1 logs in. The event integration middleware 14 does this by “publishing” this information when the event happens.

So, the event integration middleware 14 is responsible for managing user subscriptions to events, integrating and normalizing disparate events fetched by the connectors 12 from the subsystem integration layer, and notifying the applications when the subscribed event occurs. The event integration middleware 14 keeps track of event subscriptions and event occurrences such as by leveraging a temporary storage manager 64.

The event integration middleware 14 includes a publish and subscribe manager 66, an event queue manager 68, a persistence manager 70, the connection manger 50, and the temporary storage manager 64.

The publish and subscribe manager 66 allows the policy execution server 16 to specify the events of interest that have to be monitored (these are the subscribed to events) and the action that has to be taken when that event occurs. The publish and subscribe manager 66 then interacts with the event queue manager 68 to fetch the desired events. On reception of a desired event, the subscriber is notified using the publisher. Actions may be specified as part of some subscription requests, but unlike an ordinary subscription, actions result in a state change in some subsystems.

The publish and subscribe manager 66 uses, for example, XML format for all its data communication.

The publish and subscribe manager 66 needs several portions. One is the publisher which advertises the events available for subscription by applications and notifies the applications when the desired event occurs. Another is the subscriber that allows the applications to register for notification when a particular event occurs. The subscriber should also allow the applications to terminate their registered subscriptions.

The publisher and subscriber manager 66 should have the capability of maintaining a list of subscriptions (subscribed to events) and delivered notifications. Delivered notifications should be persisted until their delivery has been “acknowledged” by the subscriber. In case of duplicate subscriptions, the publish and subscribe manager 66 detects such an occurrence and optimizes requests to the underlying layer.

The publish and subscribe manager 66 operates as follows. Applications subscribe to events through a filtering mechanism by passing a filter string (based on a standard template) to the publish and subscribe manager 66. The filter conditions are described in Table 1.

TABLE 1

| Field | Sub-field(s) | Details |
|---|---|---|
| Event ID | — | The event ID specifies the “topic” |
| | | of interest. For example, account |
| | | logon, user logon, physical access, |
| | | network port usage etc. This serves |
| | | as the first level filter for any |
| | | event. |
| Persistence specifier | — | Specifies if events of this type |
| | | need to be persisted by the |
| | | publisher. |
| Subscription priority | — | The priority number of the |
| | | subscription; higher the number, |
| | | higher the priority. This may be |
| | | used by the event normalization |
| | | layer to “hibernate” low priority |
| | | subscriptions when the volume of |
| | | traffic is high. |
| Action needed | — | Specifies if the application needs |
| | | events monitoring or wants an |
| | | action to be performed. |
| Filter string | User name | The filter string specifies the exact |
| | | event of interest for a particular |
| | | subscriber. The sub-field names |
| | | are self-explanatory. The “custom |
| | | filter” sub-field is specific to a |
| | | given event and the content is |
| | | dictated by the respective event's |
| | | properties. Usage of the other sub- |
| | | fields also may be dictated by the |
| | | event id. |

The publish and subscribe manager 66 uses the request queue to store each subscription request. This information is passed to the connection manager 50, which monitors for the necessary events. The request could be for an action, in which case no monitoring needs to be initiated. The publish and subscribe manager 66 is notified of the occurrence of events “registered for monitoring” by the event queue manager 68 (which interfaces with the connection manager 50). In case of action requests, it is notified of the status of the action requested. On notification, the publish and subscribe manager 66 checks the subscription list to see who has subscribed to that event. The appropriate subscriber is then informed of the event.

The following lists a minimum set of methods that are used by the publish and subscribe manager 66 in order to achieve its above-described operations. An advertise method allows the publisher to advertise the events to which applications may subscribe. A subscribe method is invoked by applications to subscribe to any advertised event. An unsubscribe method is used by applications to terminate an existing subscription. A notify method is used by the publisher to propagate an event of interest to the respective subscriber.

The message filtering paradigm used by the publish and subscribe manager 66 is now described. The message filtering paradigm used by the publish and subscribe manager 66 is a mixture of topic-based and content-based. Since the subscribers classify the message based on a template, they do not expect to receive any other event notifications. The filtering based on event ID is topic-based system and the usage of the filter string is content-based. Table 1 above describes the filter template used by subscribers.

To check which subscription has to be notified when an event occurs, the publish and subscribe manager 66 may use a two-pass filtering approach. During the first pass, all subscriptions whose event ID matches that of the received event are short-listed. During the second pass, the short-listed subscriptions are then processed to find the exact match.

The publish and subscribe manager 66 may be multi-threaded. One thread interacts with the event registration layer to fetch the desired event for a subscription. A common thread keeps track of the registered event queue and matches the events received with those that were registered. The publishing of events may be handled by another thread.

Any other mechanism that is equivalent to the above-described functionality, such as remote procedure calls or message queues, can be used instead of the publish and subscribe manager 66.

The policy execution server 16 will persist the events reported by the publish and subscribe manager 66. However, in case of certain high priority events of interest, the policy execution 42 can ask the publish and subscribe manager 66 to persist such events. The publish and subscribe manager 66 uses the persistence manager 70 for such needs. The persistence manager 70 may also be used by the components of the policy execution 42 and a configuration tool 72 to realize its persistence needs.

The persistence manager 70 should allow the creation of a database, access to or modification of data in an existing database, and abstraction of the underlying schema by offering application programming interfaces (APIs) such as getData (to get data out of the database), putData (to commit data into the database), etc. These APIs can take the XML as the parameter if needed.

The abstraction provided by the persistence manager 70 can be used by the other system components for their needs, without being aware of the underlying database intricacies. For instance, the publish and subscribe manager 66 may persist, using the putData call, some events reported by the connectors 12. Such persisted events may be accessed by any component of the system 10 using the getData call. GetData is the function that takes an xml query as a parameter and returns the resultant data set as XML. PutData is the function that takes an XML file as input and persists it in the database.

The event queue manager 68 receives the event monitoring requests from the publish and subscribe manager 66. The event queue manager 68 directs these requests, along with the necessary information, to the connection manager 50, maintains the list of events reported by the system 10, and offers interfaces for the publish and subscribe manager 66 to pick events and route them to the policy execution server 42.

The event queue manager 68 also has its own throttle that helps it prevent flooding the upstream components with data at a rate which is more than they can handle, again aiding in scalability of the system 10.

The interfaces between the connectors 12 and the event integration middleware 14 are provided by the connection manager 50. The connection manager 50 routes event monitoring requests or any commands to the respective connectors 12. The information passed may be in a predetermined format such as XML format. So, the details of the connectors 12 need not be exposed to the event queue manager 68. The connection manager 50 will abstract the methods exposed by the connectors 12. The connection manager 50 is aware of all open “connections”; so, if there is a connection request to an already open connector 12, a reference to the existing connection will be returned.

Event monitoring requests, for example, can be initiated by the policy execution server 16. Each policy includes a trigger event that initiates the execution of that policy. The trigger events are the events that are to be monitored.

The connection manager 50 should have the following features: it should be aware of the various instances of each connector 12 to allow it to direct requests to the proper connector instance; it should be multithreaded to allow for scalability and simultaneous handling of multiple requests; and, it should be aware of all currently “open” connections so that duplicate requests do not get percolated down to the connectors 12.

The connection manager 50 has methods that initiate, modify, and terminate the monitoring of a desired event. These methods should be generic enough to accommodate the various connector types and should be able to cope with duplicate requests.

The methods of the connection manager 50 are listed by way of example in tables 2-6.

TABLE 2
Open Call

| Parameters | Return Value | Details |
|---|---|---|
| Event ID | Handle to the open | The open call checks |
| Filter - a simple | connection | the event id and the |
| filter that helps | | filter string and |
| identify the target | | opens a socket to the |
| device to monitor | | appropriate connector. |
| events. Options flag - | | All fields of the |
| to specify if the | | filter string may not |
| connection should be | | be used by the open |
| read only, write only, | | call. If a connection |
| read-write etc. | | with the same event id |
| | | and filter |
| | | string's already |
| | | open, it should |
| | | return a handle to |
| | | an existing |
| | | connection. |

TABLE 3
Read Call

| Parameters | Return Value | Details |
|---|---|---|
| A valid open handle | Data read from the | This call is used to |
| Filter condition (more | desired connection | monitor an existing |
| detailed than the one | | connection for the |
| in the open call) | | desired events. |
| | | The filter condition |
| | | specifies the exact |
| | | event to be monitored. |
| | | Note that the filter |
| | | condition depends on |
| | | the event id passed |
| | | in the call to open. |
| | | This call should allow |
| | | for both blocking and |
| | | non-blocking modes. |
| | | Data read is written |
| | | into the registered |
| | | event queue from |
| | | where it may be picked |
| | | by the pub-sub manager. |

TABLE 4
Write Call

| Parameters | Return Value | Details |
|---|---|---|
| A valid open handle | Status of the | This call is used to send data |
| Data to be written | operation | to a particular device. E.g., |
| | | sending command over a telnet |
| | | connection to a network switch |
| | | to help configure it. |

TABLE 5
Close Call

| Parameters | Return Value | Details |
|---|---|---|
| A valid open handle | Status of the | This call is used to close an |
| | operation | open connection. A connection |
| | | is not “completely” closed |
| | | until all open handles are |
| | | closed. |

TABLE 6
IOCTL (Input/Output Control)

| Parameters | Return Value | Details |
|---|---|---|
| A valid open handle | Status of the | This call is used to modify the |
| Modified filter | operation | properties of an existing |
| condition | | condition. |

Any temporary data storage requirements of the publish and subscribe manager 66, the event queue manager 68, or the connection manager 50 are delegated to the temporary storage manager 64. The temporary storage manager 64 ensures that there is a uniform way of realizing temporary storage requirements of the components. The temporary storage manager 64 also can offer a throttling mechanism (for regulating the rate of outgoing data) as an extended feature.

The policy builder and viewer 18 is one of the user interfaces of the system 10. The policy builder and viewer 18 provides users with an interface to define new policies and to view and edit existing policies. The policy builder and viewer 18 is tightly coupled with the policy execution server 42 and can be thought of as an interface to this server. Configuring security policies, authenticating user logons, handling multiple user privilege levels, keeping tabs on the changes being made to the policies, and alerting the users to any errors in the policy definition are responsibilities of the policy builder and viewer 18.

The policy execution server 16 includes a collection of components that are responsible for the execution of various policies defined by the user. The interface to these components is through the policy builder and viewer 18.

Execution of the activities involves registering and receiving the events of interest required by the policy. Since the registration and notification of events is handled by the publish and subscribe manager 66, the policy execution server 16 needs to interact with the publish and subscribe manager 66 to register and receive event notifications.

A policy consists of a series of actions and a set of rules to which adherence is required. The policy execution server 16 may be, therefore, realized using the following components: a workflow 74 that executes the series of actions associated with the policy; a rule engine 78 that is used to correlate diverse events; a mapper 76 that is used by the workflow 74 and the rule engine 78 to communicate with each other; and, an alarm manager 80, which analyzes the data passed by the rule engine 76 and routes alerts to the reports and UI dashboards 20.

The workflow 74 is used to define the set of actions in the policy. Moving from one action to another needs triggers. Triggers could be manual (e.g., an approval), automatic (e.g., an email), or triggers can originate from the rules themselves. The typical sequence of actions needed to initiate a workflow is as follows: the user logs into the tool that facilitates policy definition (configuration) and viewing and either creates and instantiates a new workflow or simply instantiates an existing one; the workflow 74 then waits for a trigger to initiate the first action; and, the control moves from one action to another based on triggers. Examples of triggers include an action in the IDMS, an email, an approval, etc.

Each workflow instance has a unique identifier that helps other components to direct messages to it. Any workflow that supports business process definition can be used. The workflow can either execute in the application server or may be used as a standalone component.

JBoss jBPM is a workflow webpage that provides a process-oriented programming model of a workflow with its Process Definition Language (jPDL). jPDL blends Java and declarative programming techniques and enables software to be structured around a process graph. This approach describes business processes in a common dialect that is understood by both technical and non-technical people, facilitating an easier implementation of the processes required by business people.

JBoss jBPM includes an Eclipse-based visual designer that simplifies jPDL development. The JBoss jBPM visual designer supports both a graphical and an XML code view of the business process or workflow being developed enabling people with different levels of programming skill to collaborate.

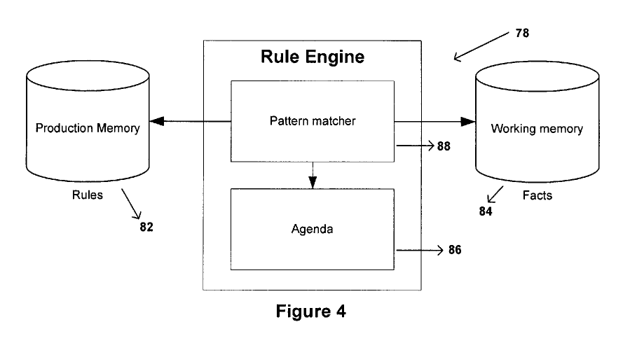

The rule engine 78 is shown in FIG. 4 and is used to execute the rules defined by the policy. The rule engine 78 subscribes to and receives events from the publish and subscribe manager 66. The events received are analyzed to see if any policy violation occurs. Analysis of the events also involves correlating the various events received by a pattern matcher 88; this correlation is necessary because the policy defined may not just depend on one violation (the rule engine 78 is, therefore, also referred to as a correlation engine). The analysis performed by the rule engine 78 may result in a trigger to the workflow 74 (for a state change) or may result in a message to the alarm manager 80.

The rule engine 78 should be such that it is simple to define new rules. Also, rules should have a logic-checking part and an action part. The logic checking part checks for the assertion of facts in the system and, when a monitored fact is asserted, an action is invoked.

A rule representation is shown as follows:

when

<conditions>

then

<actions>

Rules are stored in a production memory 82, and the facts that the inference engine matches the rules against are stored in a working memory 84. Facts (which are events for present purposes) are asserted into the working memory 84 where they may then be modified or retracted. The execution order of the rules is managed by an agenda 86. Employee1 logging in can be considered a fact/event.

The rule engine 78, for example, may be JESS (http://herzberg.ca.sandia.gov/), JRuleEngine (http://jruleengine.sourceforge.net/), or Drools (http://drools.org/). Drools can be used either as a part of the jBoss application server or as a standalone component. In Drools, rules are defined as “drl” files which contain the “when-then” part of the logic. The working memory 84 is populated using a Java code. The Java code can, therefore, be used to assert and retract facts from the working memory 84. The logic in the “drl” file checks for the facts in the working memory 84 and executes the actions.

Preferably, the users of the system 10 should not be exposed to intricacies of the rule engine language or syntax. It is, therefore, necessary to provide a user interface that can be used to define rules in a simple manner.

The Java portion of the code, which populates the facts, should be written and available in the engine. Automation should enable updating the Java files if needed by using the information provided by the users in the editor.

As for the rules (i.e., the drl files), there are multiple ways of defining them. For example, a text editor, eclipse IDE provided at Eclipse webpage: http://www.eclipse.org/, or a business rules management system (BRMS), which is a web based application that helps define rules, could be used. The Drools rule engine provides a BRMS that is user friendly. Drools also allow defining rule in a spreadsheet (using OpenOffice, Microsoft Excel etc.).

BRMS is recommended. BRMS allows rules to be defined or to be imported from Excel or drl files. Another option is to create an editor that compiles the graphical representation into a drl file or a spread sheet. Still another option is to create an eclipse plug in that simplifies the Drools eclipse IDE.

The mapper 76 of FIG. 2 is used for communication between the workflow 74 and the rule engine 78. The mapper 76 performs the following roles: the mapper 76 is used by the workflow 74 to start the rule engine 78 and to pass data to the rule engine 78; the data includes the workflow ID, attributes that may be needed for the execution of the rules, etc.; the mapper 76 maintains a map of all the workflow instances and the rules with which the workflow instances communicate; and, when any rule fires, the result may need to be passed to a specific workflow instance, which is done by the mapper 76 as it maps specific workflow instances to corresponding rules. An instance is an independent entity. For example, HR may use a workflow to manage the various phases of employee separation. There will one instance of the workflow created for every employee who resigns.

The alarm manager 80 is responsible for handling the various alarms in the system, their acknowledgments, etc. The features of the alarm manager 80 are as follows: all the system alarms are passed to the alarm manager 80 by the rule engine 78; the alarm manager 80 passes alarms to the report and UI dashboard 20 and receives acknowledgments of those alarms; any alarms not acknowledged within a predefined time are escalated; the escalation mechanisms include sending emails to specific users, raising a higher priority alarm to the dashboard, etc.; the alarm manager 80 has to persist all alarms related information such as alarms received, alarms acknowledged, and the ID of the user who acknowledged a specific alarm.

The alarm manager 80 may send and receive all its data in XML format.

A policy, for example, may be built to prohibit the use of USB by contractors. A contractor swiping into a conference room is an event (say Event1). A USB device being plugged into one of the computers in the conference room is another event (Event2). The contractor swiping out of the conference room is the third event (Event3). Event1 followed by Event3 or Event2 followed by Event3 are not policy violations. However, Event1 followed by Event2, but before Event3 is a violation of the policy.

If all data interchanges between components in the system 10 are in XML format, the system 10 includes an Xml parser 90. While commercial off the shelf (COTS) components such as the workflow 74 and the rule engine 78 may have inherent XML parsing capabilities, other components such as the alarm manager 80, the connection manager 50, and some connectors 12 would need an XML parser to handle XML data.

Any COTS or open source XML parsers may be used, e.g., —Xerces (http://xerces.apache.org.), the .xml parser in Microsoft NET etc.

The system 10 further includes a command console 92. The command console 92 assists users to drive some actions. When the user notices any alert on the system 10 that requires an action, the user can leverage the command console 92 to drive such actions. The command console 92 may be required if the policy execution server 16 only keeps track of system events and performs correlation to trap alarms in the system. The command console 92 need not be capable of initiating any actions that may be needed.

The features of the command console 92 are as follows: the command console 92 should list the set of commands that users may perform on the event sources; the set of commands should be commensurate with the features supported by the event sources; and, the list depends on the privilege level of the user. The actions should be passed on to the pub sub layer and the acknowledgment should be stored; and, the history of the actions performed and the IDs of the users who initiated the action should be stored for later audits if necessary.

The architecture of FIGS. 1 and 2 preferably has pertinent enterprise configuration information for its execution. This configuration information is provided by the configuration tool 72 and includes data such as zone to workstation mapping, mapping of switch port to the physical location of workstation, etc. The configuration tool 72 uses the persistence manager 70 to store the configurations. The configuration information may be used by various system components for their operations.

The policy execution server 16 and the dashboard 30 are examples of components that use mapping. For example, a policy may be built that blocks a contractor's physical accesses in a zone where a contractor is present and there is an unusual amount of network activity on one of the computers in that zone. The policy execution server 16 will have to rely on the configuration tool's “zone to workstation mapping” to figure out that the machine from which the unusual amount of network traffic is originating is in the same zone as the contractor.

The features of the configuration tool 72 and the configurations that can be defined are as follows: access to the configuration tool 72 is regulated by a user manager 94; the configuration is persisted by availing the services of the persistence manager 70; and, the configuration tool 72 should provide for IT map configuration and zone information. IT map configuration is a list of all prominent IT devices, such as domain controllers, switches, etc., and their locations. Zone information is a list of the all zones and any specific access control policies governing those zones.

The report and UI dashboard 20 is an operational user interface to the system 10. It allows the user to view the various events in the systems, the alerts, and the list of policy breaches with the supporting data. The report and UI dashboard 20 allows for user authentication, and the view offered depends on the user privilege levels.

The report and UI dashboard 20 also provides for a report builder that generates the reports as per the layout defined by the user. There can be a report designer interface and another operational view from which the user can generate, print, and send reports.

Custom user interface widgets for alarm management, reports, and the information from these will be used to compose the report and UI dashboard 20. The report and UI dashboard 20 may be a container to host the widgets. Data needed by the report and UI dashboard 20 is sourced from the policy execution server 16.

The user manager 94 is a simple process that handles authentication from the user and passes connection referrals back to the user. It is, therefore, not anticipated that more than one login server will be needed. The requirements for this subsystem revolve around security and availability.

All the components of the system 10 such as the command console 92, policy builder and viewer 18, the report and UI dashboard 20, and the configuration tool 72 depend on the user manager 94 for their authentication needs.

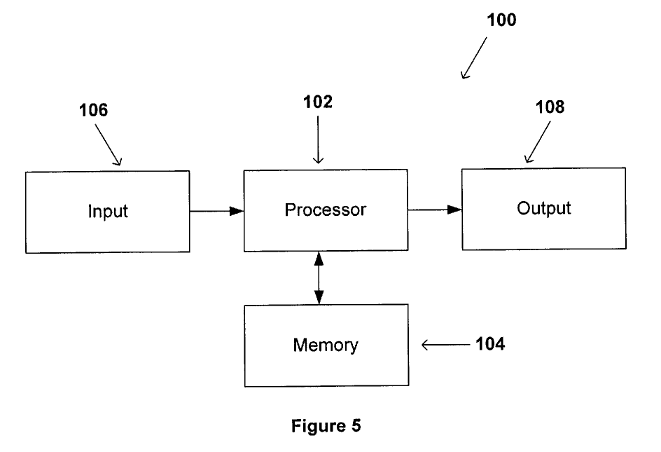

FIG. 5 shows a computer system 100 as one example of a implementation of the physical and logical domain security system 10. The computer 100 includes a processor 102, a memory 104, an input device(s) 106, and an output device(s) 108. The computer system 100 implements, for example, the event integration middleware 14, the policy execution server 16, the policy builder and viewer 18, the report and user interface (UI) dashboard 20, the configuration tool 72, the XML parser 90, the command console 92, and/or the user manager 94.

The input device(s) 106 can include one or more of the usual computer input devices such as a mouse, a keyboard, etc. However, the input device(s) 106 can also include the connectors 12. The input device(s) 106 are further used to execute the policy building of the policy builder and viewer 18.

The output device(s) 108 can include one or more of the usual computer output devices such as a printer, a monitor, etc. However, the output device(s) 108 can also include the reports and UI dashboards 20. The input device(s) 106 are further used to execute the viewer portion of the policy builder and viewer 18.

The memory 104 stores the policies and rules described above as well as various applications such as the event integration middleware 14, a policy execution server 16, a policy builder and viewer 18, and a report and user interface (UI) dashboard 20. In addition, the memory 104 can store other applications that may be appropriate to the physical and logical domain security system 10 and/or to other tasks to be run on the computer 100.

The processor 102 executes the various applications.

The computer 100 is coupled by the connectors 12 over a network to the subsystems such as an IDMS subsystem 24, the physical access control 28, the information technology systems 32 as well as to the domain controller 44, the various user machines 46, and the various switches 48. The connectors 12 may be part of the input device(s) 106.

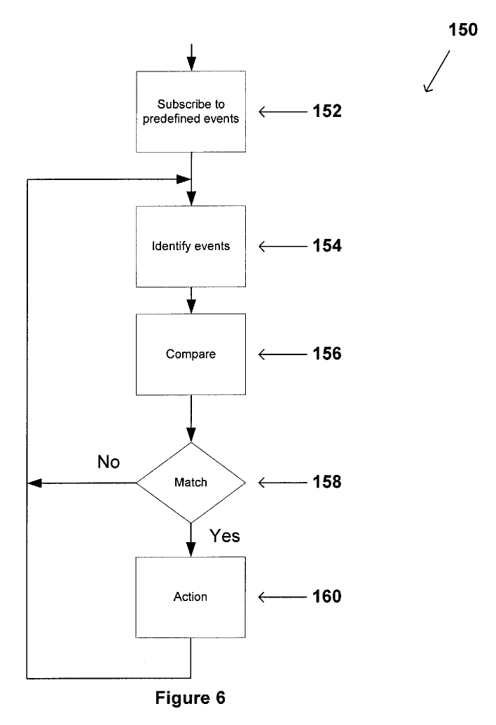

FIG. 6 illustrates a flow chart of a program 150 that may be executed by the computer system 100 to identify threats to an enterprise. At 152 of the program 150, only those events that correspond to event portions of a set of policies are subscribed to as described above. This subscription eliminates the necessity of processing all events that occur in the physical and/or logical domain. Thus, only those events that correspond to the event or condition portions of the defined policies need to be processed by the program 150.

At 154, a subset of the subscribed to events in the physical domain and/or logical domain are identified. A subset of the subscribed to events contains one or more of the subscribed to events depending on the number of events contained the event or condition portions of the policies in the defined set of policies. At 156, the identified subset of the subscribed to events is compared to the event portions of the policies.

Only if the identified subset of the subscribed to events compares favorably to the event portion of at least one of the policies as determined at 158, an action corresponding to the event portion of the at least one of the policies is performed at 158.

After the action is performed at 160 or if the identified subset of the subscribed to events does not compare favorably to the event portion of at least one of the policies as determined at 158, program flow returns to 154 to identify other subsets of events.

The comparison of the identified subset of subscribed to events to the event portions of the policies at 156 may be performed in the context of a configuration of the enterprise. The actions performed 160 can include any one or more of locking a user out of a network, locking a user out of a subset of applications, locking a user out of a subset of data, etc.

Modifications of the present invention will occur to those practicing in the art of the present invention. For example, as described above, the computer system 100 implements, for example, the event integration middleware 14, the policy execution server 16, the policy builder and viewer 18, the report and user interface (UI) dashboard 20, the configuration tool 72, the XML parser 90, the command console 92, and/or the user manager 94. Alternatively, one or more of the event integration middleware 14, the policy execution server 16, the policy builder and viewer 18, the report and user interface (UI) dashboard 20, the configuration tool 72, the XML parser 90, the command console 92, and/or the user manager 94 may be implemented by one or more other computers or dedicated devices.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. An enterprise threat assessment and management system to provide physical and logical security comprising:
at least one physical access control system configured to identify physical events in the physical domain;
at least one logical access control system configured to identify logical events in the logical domain;
at least one first connector to establish uninterrupted coupling between the at least one physical access control system and the enterprise threat management system;
at least one second connector to establish uninterrupted coupling between the at least one logical access control system and the enterprise threat management system;
at least one event middleware system configured to selectively subscribe only to events from the at least one physical access control system and the at least one logical access control system that correspond to at least one set of policy definitions; and,
at least one policy definition and execution system configured to build and execute policies, wherein the policies are in the at least one set of policy definitions, wherein the policies define a correlation of the physical and logical events, and wherein the at least one policy definition and execution system initiates action depending upon the correlated physical and logical events defined by the policies.

2. The system of claim 1, wherein the at least one first connector is configurable as a plurality of instances to handle events from physical devices of the same type, and wherein the at least one second connector is configurable as a plurality of instances to handle events from logical devices of the same type.

3. The system of claim 1, wherein the at least one event middleware system includes a publish and subscribe system configured to manage the selective subscription.

4. The system of claim 1, wherein the event middleware system includes a persistence system that persists the selective subscriptions as a function of priorities defined by the at least one policy definition and execution system.

5. The system of claim 1, further comprising a configuration tool that provides configuration data about the enterprise.

6. The system of claim 1, wherein the at least one first connector is located locally at the at least one physical access control system and communicates remotely with the at least one event middleware system, and wherein the at least one second connector is located locally at the at least one logical access control system and communicates remotely with the at least one event middleware system.

7. The system of claim 1, wherein the at least one first connector is located locally at and communicates locally with the at least one event middleware system, and wherein the at least one second connector is located locally at and communicates locally with the at least one event middleware system.

8. The system of claim 1, wherein the at least one event middleware system collates only subscribed to events.

9. The system of claim 1, wherein the at least one policy definition and execution system is configured to build and execute policies in the form of rules.

10. A method of assessing and managing threats within an enterprise so as to provide physical and logical security comprising:
identifying at least one physical event in a physical domain;
identifying at least one logical event in a logical domain;
managing a plurality of workflow instances that identify the physical or logical events;
selectively subscribing to at least one of the physical and logical events characterized by the workflow instances as a function of at least one set of policy definition;
correlating the physical and logical events as a function of the policy definition; and,
executing an action related to the correlation in the context of the physical or logical domain.

11. The system of claim 10, further comprising persisting the selective subscriptions as a function of priorities defined by the policy definition.

12. The method of claim 10, further comprising processing configuration data, wherein the configuration data relates to configuration of the enterprise.

13. The method of claim 10, receiving the at least one physical event from a remotely located connector that is associated with a physical system that generated the physical event, and receiving the at least one logical event from a remotely located connector that is associated with a logical system that generated the logical event.

14. The method of claim 10, receiving the at least one physical event from a locally located connector that is associated with a physical system that generated the physical event, and receiving the at least one logical event from a locally located connector that is associated with a logical system that generated the logical event.

15. The method of claim 10, further comprising collates similar physical and logical events.

16. The method of claim 10, wherein the correlating of the physical and logical events as a function of the policy definition comprises correlating the physical and logical events as a function of rules constructed to implement the policy definition.

17. A method of assessing a security threat to an enterprise comprising:
subscribing only to those events that correspond to event portions of a set of policies, wherein each policy in the set of policies includes a corresponding one of the event portions and a corresponding action portion;
identifying a subset of the subscribed to events in a physical domain and/or logical domain, wherein a subset comprises one or more of the subscribed to events;
comparing the identified subset of the subscribed to events to the event portions of the policies; and,
only if the identified subset of the subscribed to events compares favorably to the event portion of at least one of the policies, performing an action corresponding to the event portion of the at least one of the policies.

18. The method of claim 17 wherein the comparing of the identified subset of subscribed to events to the event portions of the policies comprises comparing the identified subset of subscribed to events to the event portions of the policies in context of a configuration of the enterprise.

19. The method of claim 17 further comprising communicating messages have a predetermined format, and wherein the comparing of the identified subset of subscribed to events to the event portions of the policies comprises parsing the messages.

20. The method of claim 19 wherein the predetermined format comprises an XML format.

21. The method of claim 17 further comprising permitting a user to define and build the policies in the set of policies.

22. The method of claim 17 wherein the performing of an action comprises locking a user out of a network.

23. The method of claim 17 wherein the performing of an action comprises locking a user out of a subset of applications.

24. The method of claim 17 wherein the performing of an action comprises locking a user out of a subset of data.

25. The method of claim 17 wherein the performing of an action comprises locking a user out of a room within a building.

26. The method of claim 17 wherein the performing of an action comprises generating an alarm.
